(19) United States
(12) Patent Application Publication
(10) Pub. No.: US 2026/0023506 A1
(43) Pub. Date: Jan. 22, 2026

(54) DATA STORAGE SYSTEM AND OPERATING METHOD OF DATA STORAGE SYSTEM

(71) Applicant: SK hynix Inc., Icheon-si (KR)

(72) Inventors: Ku Ik KWON, Icheon-si (KR); Seung Hwan KIM, Icheon-si (KR); Hee Cheol KIM, Icheon-si (KR); Byoung Min JIN, Icheon-si (KR)

(21) Appl. No.: 19/260,284

(22) Filed: Jul. 4, 2025

(30) Foreign Application Priority Data
Jul. 19, 2024 (KR) 10-2024-0095661

(51) Int. Cl. G06F 3/06

(52) U.S. Cl. CPC G06F 3/0659; G06F 3/0613; G06F 3/0673

(57) ABSTRACT

The present technology provides a data storage system, comprising: a data storage device and a controller configured to receive read requests from a host and control the data storage device by generating first read commands to read the data corresponding to first addresses. The controller is further configured to: generate second read commands to read the data corresponding to second addresses that are consecutive to the first addresses, in response to presence of a parallel-read execution condition during processing of the first read commands; make a comparison of a read command number with an outstanding first read count; assign each of the first read commands and the second read commands to either a first command processing operation or a second command processing operation based on a result of the comparison; and perform the first and second command processing operations in parallel within the reference time.

### PRIORITY CLAIM AND CROSS-REFERENCE TO RELATED APPLICATION

This application claims priority under 35 U.S.C. § 119 to Korean Patent Application No. 10-2024-0095661 filed on Jul. 19, 2024, which is incorporated herein by reference in its entirety.

### TECHNICAL FIELD

Embodiments of the present disclosure relate to a data storage system and an operating method of the data storage system.

### BACKGROUND

A data storage system corresponds to a storage device that stores data based on a request from a host such as a computer, a mobile terminal (e.g., a smartphone or tablet), or various electronic devices. The data storage system may include not only a device that stores data on a magnetic disk, such as a Hard Disk Drive (HDD), but also a device that stores data in non-volatile memory, such as a Solid State Drive (SSD), Universal Flash Storage (UFS), or an embedded Multi Media Card (eMMC).

The data storage system may further include a controller that controls a data storage device (e.g., a volatile memory or a non-volatile memory). The controller may receive a request from the host and process or control read, write, or erase operations on the data storage device included in the data storage system, based on the received request. The controller may also perform firmware configured to carry out logical operations for processing or controlling these operations.

Meanwhile, the data storage system may cache data stored in the data storage device into cache memory to more quickly process a normal-read operation requested by the host. In this case, the data storage system may cache data requested for reading by the host or may also preemptively cache data in the cache memory before the host issues a read request.

### SUMMARY

Various embodiments of the present disclosure are directed to an apparatus and a method for processing read commands based on the deterioration state of a memory device.

The technical objectives achievable by the present disclosure are not limited to those described herein. Other technical objectives not explicitly described will be readily understood by those skilled in the art to which the present disclosure pertains based on the following description.

According to embodiments of the disclosed technology, a data storage system and an operating method thereof are provided that are capable of efficiently processing a parallel-read operation by controlling a plurality of cores.

In one embodiment, the data storage system may include a controller configured to assign read commands to multiple cores and process the read commands in parallel, thereby reducing overall read latency.

In another embodiment, the data storage system may minimize a response time for a read request received from a host by dynamically determining whether to perform a single-read operation or a parallel-read operation based on the number of unprocessed commands and the command processing capability of each core.

Further, the data storage system may determine an optimal read scheduling strategy by considering the workload and operating speed of the plurality of cores, and may selectively assign read commands to each core in a manner that maximizes processing efficiency within a given time constraint.

In an embodiment of the present disclosure, a data storage system, comprising: a data storage device including a storage region configured to store data; and a controller in communication with a host outside the data storage system and configured to receive read requests from the host and control the data storage device by generating first read commands to perform first read operations to read the data corresponding to first addresses corresponding to the read requests received from the host, wherein the controller is further configured to: generate second read commands to perform second read operations to read the data corresponding to second addresses that are consecutive to the first addresses, in response to presence of a parallel-read execution condition during processing of the first read commands; make a comparison of a read command number with an outstanding first read count indicating a number of unprocessed first read commands, wherein the read command number represents a number of read commands that are processable by the controller within a reference time and include at least one of the first read commands and the second read commands; assign each of the first read commands and the second read commands to either a first command processing operation or a second command processing operation based on a result of the comparison; and perform the first and second command processing operations in parallel within the reference time.

The controller may include: a first core configured to perform the first command processing operation; and a second core configured to perform the second command processing operation under control by the first core, wherein the first core may be a main-core configured to control the data storage device to perform the read commands, and wherein the second core may be a sub-core configured to control the data storage device to perform the read commands.

The reference time may include: a time required for the second core to complete a particular number of the second read commands, the particular number being a reference count.

In an another embodiment of the present disclosure, a method of operating a data storage system, wherein the data storage system includes a data storage device having a storage region configured to store data and a controller configured to control the data storage device, and wherein the method comprises: generating first read commands to read the data corresponding to first read requests received from a host that is outside the data storage system; generating second read commands to read data corresponding to second addresses that are consecutive to first addresses of unprocessed first read commands, in response to a parallel-read execution condition being satisfied; making a comparison of a read command number with an outstanding first read count indicating a number of the unprocessed first read commands, wherein the read command number represents a number of read commands that are processable by the controller within a reference time and include at least one of a number of first read commands and the second read commands; assigning each of the unprocessed first read commands and the second read commands to either a first command processing operation or a second command processing operation, based on a result of the comparison; and performing the first and second command processing operations in parallel during the reference time.

The first command processing operation may be processed by a first core for performing the first read commands, and wherein the second command processing operation is processed by a second core for performing the second read commands under control of the first core.

The reference time may include: a time required for the second core to complete a particular number of the second read commands, the particular number being a reference count.

### BRIEF DESCRIPTION OF THE DRAWINGS

FIG. 1 is a diagram of a data processing system based on some implementations of the disclosed technology.

FIG. 2 is a diagram of a processing system based on some implementations of the disclosed technology.

FIG. 3 is a diagram illustrating an example of a data storage system processing a pre-read operation, based on some implementations of the disclosed technology.

FIG. 4 is a diagram illustrating an example of a data storage system processing a normal-read operation, based on some implementations of the disclosed technology.

FIG. 5 is a flowchart illustrating a method by which a data storage system determines how to process a read operation, based on some implementations of the disclosed technology.

FIGS. 6 to 9B are detailed diagrams illustrating a method of processing a parallel-read operation based on a first embodiment of the disclosed technology.

FIG. 10 is a flowchart illustrating a method of processing a parallel-read operation based on a second embodiment of the disclosed technology.

FIG. 11 is a flowchart illustrating a method of calculating the number of read commands, as described in FIG. 10.

FIGS. 12 and 13 are diagrams illustrating examples of a method for assigning read commands, as described in FIG. 10.

FIGS. 14A to 17 are diagrams illustrating examples of assigned read commands.

### DETAILED DESCRIPTION

Hereinafter, various embodiments of the present disclosure will be described in detail with reference to the accompanying drawings. In the following description, only parts necessary for understanding the operation according to an embodiment of the present disclosure will be described, and descriptions of other parts will be omitted so as not to obscure the subject matter of the present disclosure.

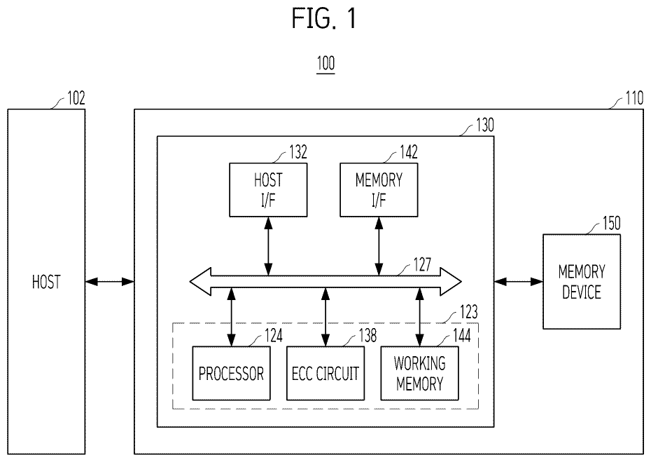

FIG. 1 is a diagram of a data processing system according to an embodiment of the disclosed technology.

Referring to FIG. 1, a data processing system 100 according to embodiments of the disclosed technology may include a host 102 and a data storage system 110. The data storage system 110 may include a memory device 150 for storing data and a controller 130 for controlling the memory device 150.

The memory device 150 may include a plurality of memory blocks and may operate under the control of the controller 130. Operations of the memory device 150 may include, for example, a read operation, a program (write) operation, and an erase operation.

The read operation may be classified as either a normal-read operation or a pre-read operation, depending on whether a read request is issued by the host 102. For example, the normal-read operation reads data after the host 102 issues the read request and the pre-read operation reads data before the host 102 issues the read request. The read operation may also be classified as a single-read operation or a parallel-read operation, depending on the number of agents performing the read operation. For example, the single-read operation is processed by the single agent and the parallel-read operation is processed by the multiple agents.

For example, the memory device 150 may be implemented using various types of memory such as DDR SDRAM (Double Data Rate Synchronous Dynamic Random Access Memory), LPDDR4 SDRAM, GDDR SDRAM, LPDDR, RDRAM (Rambus DRAM), NAND flash memory, 3D NAND flash memory, NOR flash memory, Resistive RAM (RRAM), Phase-Change RAM (PRAM), Magnetoresistive RAM (MRAM), Ferroelectric RAM (FRAM), or Spin-Transfer Torque RAM (STT-RAM).

The memory device 150 may be implemented as a three-dimensional array structure. Embodiments of the disclosed technology may be applied to flash memory devices having a charge storage layer formed of a conductive floating gate or to Charge Trap Flash (CTF) memory in which the charge storage layer is formed of an insulating layer.

The memory device 150 is configured to receive a command and an address from the controller 130 and to access a memory cell array selected by the address. That is, the memory device 150 may perform an operation corresponding to the received command on the selected memory area.

For example, the memory device 150 may perform read, program, and erase operations. During a program operation, the memory device 150 writes data to the area selected by the address. During a read operation, the memory device 150 reads data from the selected area, and during an erase operation, the memory device 150 erases data from the area.

In embodiments of the disclosed technology, the normal-read operation may include reading data requested by the host 102 from the memory device 150 and storing the read data in cache memory. The pre-read operation may include pre-reading data that has not yet been requested by the host 102 but is likely to be requested, and storing the pre-read data in the cache memory.

The controller 130 may control the read, program, and erase operations, as well as background operations, for the memory device 150. Here, the background operations may include, for example, garbage collection (GC), wear leveling (WL), and bad block management (BBM).

The controller 130 may control the memory device 150 based on a request from the host 102 or independently of a host request.

The controller 130 and the host 102 may be implemented as separate devices. In some cases, however, they may be integrated into a single device. For convenience of explanation, the controller 130 and the host 102 are described below as separate devices.

Referring to FIG. 1, the controller 130 may include a host interface 132, a control circuit 123, and a memory interface 142.

The host interface 132 provides a communication interface between the data storage system 110 and the host 102.

The control circuit 123 may process a command corresponding to a request received from the host 102.

The memory interface 142 provides a communication interface between the controller 130 and the memory device 150 under the control of the control circuit 123.

The control circuit 123 controls overall operations of the controller 130 and the operations of the memory device 150. For this purpose, the control circuit 123 may include a processor 124 and a working memory 144, and may further include an error detection and correction circuit (ECC 138), among others.

The processor 124 may control the overall operation of the controller 130 and perform logical operations. It may communicate with the host 102 through the host interface 132 and with the memory device 150 through the memory interface 142.

The processor 124 may perform the function of a flash translation layer (FTL). The processor 124 may convert a logical block address provided by the host 102 into a physical block address using a mapping table through the flash translation layer (FTL).

An address mapping method of the flash translation layer (FTL) may vary depending on the mapping unit. Representative methods include page mapping, block mapping, and hybrid mapping.

The processor 124 may be configured to randomize data received from the host 102. For example, the processor 124 may randomize the data using a randomizing seed. The randomized data may then be provided to the memory device 150 for storage in a memory cell array.

The processor 124 may be configured to de-randomize data received from the memory device 150 during a read operation. For example, the processor 124 may de-randomize the data using a de-randomizing seed. The de-randomized data may then be transmitted to the host 102.

The processor 124 may control the operation of the controller 130 using firmware. It may also control the overall operation of the controller 130 and execute firmware loaded into the working memory 144 at boot time to perform logical operations.

The firmware is a program executed in the data storage system 110 and may include various functional layers. For example, the firmware may include one or more of the following: a flash translation layer (FTL), which converts a logical block address requested by the host 102 into a physical block address of the memory device 150; a host interface layer (HIL), which interprets the request from the host 102 and transmits it to the FTL; and a flash interface layer (FIL), which transmits the command from the FTL to the memory device 150. The firmware may be stored in the memory device 150 and loaded into the working memory 144.

The working memory 144 may store firmware, program code, commands, or data required for operating the controller 130. It may be a volatile memory and may include one or more of the following: static RAM (SRAM), dynamic RAM (DRAM), or synchronous DRAM (SDRAM).

The ECC 138 may be configured to detect an error bit in verification target data using an error correction code and to correct the detected error bit.

The ECC 138 may decode data using an error correction code and may be implemented with various types of code decoders. For example, a decoder that performs systematic or non-systematic code decoding may be used.

For example, the ECC 138 may detect an error bit in each unit of read data, based on sectors. Each unit of read data may include a plurality of sectors. A sector refers to a data unit smaller than a page, which is the read unit of the flash memory. The sectors included in each unit of read data may correspond to one another through addressing.

The ECC 138 may calculate a bit error rate (BER) for each data sector and determine whether each data sector is correctable. For example, if the BER exceeds a reference value, the ECC 138 may determine the data sector to be “Uncorrectable” or a “Fail.” Conversely, if the BER is below the reference value, the data sector may be determined to be “Correctable” or a “Pass.”

The ECC 138 may sequentially perform error detection and correction operations on all read data. If a data sector included in the read data is determined to be correctable, the ECC 138 may omit the corresponding operation for that data sector in the next cycle. Once the error detection and correction operations for all read data are completed, the ECC 138 may identify the data sectors determined to be uncorrectable. There may be one or more such data sectors. The ECC 138 may then transmit information (e.g., an address) regarding the uncorrectable data sectors to the processor 124.

A bus 127 may be configured to provide a communication channel between the components 132, 142, 124, 144, and 138 of the controller 130. The bus 127 may include, for example, a control bus for transmitting various control signals and commands, and a data bus for transmitting data.

The aforementioned components of the controller 130 are merely illustrative examples. Some of the components may be omitted or integrated. In some embodiments, one or more additional components may be included in the controller 130.

In embodiments of the disclosed technology, the data storage device may include at least one of a volatile memory and a non-volatile memory. The data storage device may include at least one of the memory device 150 and the working memory 144 included in the data storage system 110. Additionally, the data storage device may include at least one of a volatile memory and a non-volatile memory located outside the data storage system 110, for example, in the host.

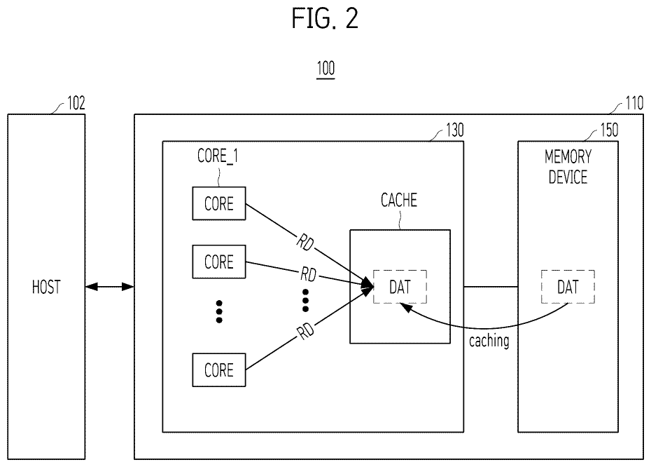

FIG. 2 is a diagram of a processing system according to an embodiment of the disclosed technology. Descriptions of parts which have been already described with reference to FIG. 1 will be omitted.

Referring to FIG. 2, the controller 130 of the data storage system 110 may include a plurality of cores CORE and a cache memory CACHE. The data storage system 110 may include a solid-state drive (SSD).

In embodiments of the disclosed technology, the plurality of cores CORE may perform normal-read operations requested by the host 102. Each core may be implemented as a module configured to perform such operations. Each core may have a different identifier and may use either a unique namespace or a shared namespace.

The host 102 may operate on different physical devices, or may include multiple virtual hosts operating on a single physical device. When each core is associated with a virtual host, an intermediate operating system may manage the interface between the physical device and the virtual host operating systems.

Each of the plurality of cores CORE may be configured as an independent circuit or as a hardware or software module operating on a shared circuit. In such cases, each core may include an independent control register.

For example, when the data storage system 110 communicates with the host 102 using the PCIe protocol, each of the plurality of cores CORE may share a single PCIe port. Additionally, each core may function as an NVMe controller module capable of performing a PCI function for the host 102.

The plurality of cores CORE may perform operations of a host interface layer HIL, a flash translation layer FTL, and a flash interface layer FIL. In some implementations, the cores may be implemented as firmware modules driven by the processor 124 (FIG. 1) of the controller 130, or as hardware modules embedded in the processor 124.

The cache memory CACHE may cache data DAT read from the memory device 150. For example, the cache memory CACHE may be configured as a specific memory region or memory chip within the working memory (144 in FIG. 1) of the controller 130. In embodiments of the disclosed technology, the data DAT may correspond to consecutive logical block addresses and represent consecutive data that are logically related. The read request may be a consecutive read request transmitted by the host 102 to retrieve data DAT stored in the memory device 150.

In embodiments of the disclosed technology, the cache memory CACHE may be shared by the plurality of cores CORE. Alternatively, the cache memory CACHE may include different storage regions allocated to each core. The controller 130 may allocate or release one or more cache regions to store different types of data.

The first core CORE_1, which is one of the plurality of cores CORE, may read data from the cache memory CACHE instead of accessing the memory device 150. Accordingly, the first core CORE_1 may quickly process the normal-read operation requested by the host 102.

If the data is already cached in the cache memory CACHE, the controller 130 may transmit the cached data to the first core CORE_1. Otherwise, the controller 130 may read the data from the memory device 150, store it in the cache memory CACHE, and then transmit it to the first core CORE_1.

The pre-read operation refers to a read look-ahead (RLA) operation that reads data not yet requested by the host 102. The controller 130 may determine that data stored at a specific address in the memory device 150 has not yet been requested but is likely to be requested soon, based on the read request pattern of the host 102. In such a case, the controller 130 may cache the data in the cache memory CACHE in advance, even if no read request has been issued from the host 102.

For example, when the read request pattern of the host 102 is consecutive, the controller 130 may determine to perform a pre-read operation. If the host 102 requests data corresponding to a first address since the read requests from the host 102 are usually consecutive, the controller 130 may determine that data at a second address adjacent to the first address is likely to be requested next. Accordingly, the controller 130 may read the data at the second address in advance and cache it in the cache memory CACHE.

In this manner, the controller 130 may cache the data corresponding to the second address, which corresponds to the data the host 102 is likely to request, in the cache memory CACHE. When the data corresponding to the second address is cached in the cache memory CACHE, if the read request for the data is issued by the host 102 subsequent to the first address, the controller 130 may transmit it from the cache memory CACHE without accessing the memory device 150, thereby reducing response time and read latency.

The controller 130 may generate a read command to control a read operation RD of the data storage device. The read operation RD may include caching data from the memory device 150 into the cache memory CACHE of the controller 130. The read operations RD may include both a normal-read operation and a pre-read operation. The controller 130 may transmit the read command to the memory device 150 to perform the read operation RD.

Hereinafter, for convenience of explanation, the controller 130 will be described as including only two cores, i.e., the first core CORE_1 and the second core CORE_2, and the data storage device will be described as including only the memory device (150 in FIG. 1). However, the number of cores included in the controller 130 and the number of memory device 150 included in the data storage device are examples only and other implementations are also possible. In the following description, the reference numeral ‘150’ may be used to represent the data storage device.

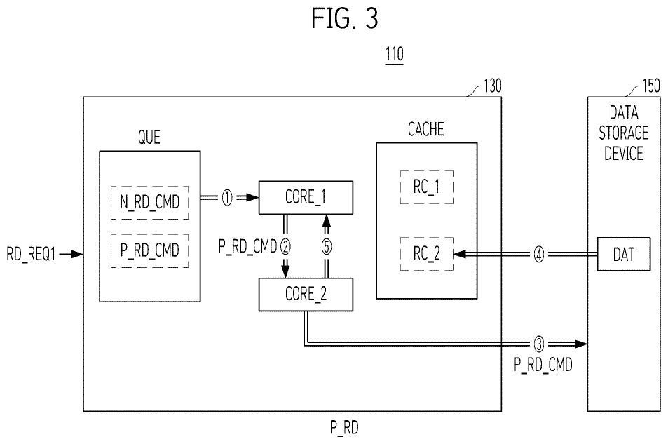

FIG. 3 is a diagram illustrating an example of a data storage system performing a pre-read operation according to an embodiment of the disclosed technology. In particular, FIG. 3 shows a case where the second core CORE_2 performs a pre-read operation instead of the first core CORE_1.

When read requests are received from the host 102, the first core CORE_1 may generate one or more normal-read commands corresponding to the read requests received from the host 102. The controller 110 controls the normal-read operation performed by the data storage device 150 based on the normal-read commands. The normal-read commands may be sorted in the order in which the read requests were received and stored in the queue QUE. Referring to FIG. 3, when a first read request RD_REQ1 is received from the host 102, the first core CORE_1 may generate a plurality of normal-read commands N_RD_CMD corresponding to the first read request RD_REQ1 to perform a normal-read operation.

The cache memory CACHE may include a first cache RC_1 allocated to the first core CORE_1 and a second cache RC_2 allocated to the second core CORE_2. The operations \textcircled{1} to \textcircled{5} as shown in FIG. 3 will be discussed in detail in the below.

\textcircled{1} The first core CORE_1 may analyze a read request pattern based on the plurality of normal-read commands N_RD_CMD stored in the queue QUE. Based on the analysis result, the first core CORE_1 may determine whether a pre-read operation needs to be performed.

If it is determined that a pre-read operation is required, the first core CORE_1 may generate at least one pre-read command P_RD_CMD and store it in the queue QUE. Addresses corresponding to the pre-read command P_RD_CMD may be consecutive with the addresses of the normal-read command N_RD_CMD. Both the normal-read commands N_RD_CMD and the pre-read commands P_RD_CMD stored in the queue QUE may remain in an outstanding state which refer to the state which has not been processed yet.

\textcircled{2} The first core CORE_1 may transmit the generated pre-read command P_RD_CMD to the second core CORE_2.

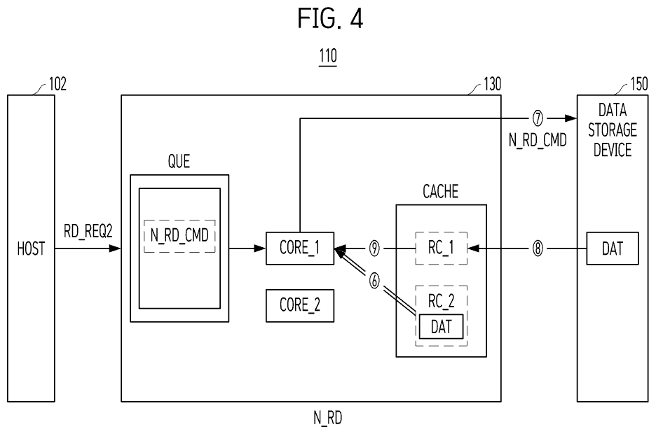

\textcircled{3} The second core CORE_2 may transmit the received pre-read command P_RD_CMD to the memory device 150. \textcircled{4} Upon receiving data DAT from the memory device 150, the second core CORE_2 may cache the data in the second cache RC_2. \textcircled{5} Then, the second core CORE_2 may transmit a message to the first core CORE_1 indicating that the data DAT has been cached. Through this process, the data DAT may be cached in advance in the second cache RC_2 before a second read request (e.g., as shown in FIG. 4) is received from the host 102. However, since the host 102 has not actually issued the second read request, the first core CORE_1 does not transmit the cached data DAT to the host 102.

FIG. 4 is a diagram illustrating an example of a data storage system performing a normal-read operation according to an embodiment of the disclosed technology. In particular, FIG. 4 illustrates a case in which the first core CORE_1 performs the normal-read operation.

Referring to FIG. 4, when a second read request RD_REQ2 is received from the host 102, the first core CORE_1 may generate a normal-read command N_RD_CMD corresponding to the second read request RD_REQ2. The first core CORE_1 may determine whether at least a portion of the data DAT corresponding to the second read request RD_REQ2 is already cached (i.e., whether a cache hit occurs) in the second cache RC_2 as a result of the pre-read operation performed in FIG. 3.

If the data DAT is cached in the second cache RC_2, the first core CORE_1 may read the cached data DAT and transmit it to the host 102. A Direct Memory Access (DMA) operation may be performed between the second cache RC_2 and the first core CORE_1. The timing at which the first core CORE_1 determines that the normal-read operation has been completed may be immediately after the data DAT is transmitted to the host 102.

For example, the normal-read command N_RD_CMD corresponding to the second read request RD_REQ2 may include logical block addresses LBA<1:50>. Among them, only the data corresponding to ten logical block addresses LBA<1:10> may be cached in the cache memory CACHE. The first core CORE_1 may determine that only the portion of the normal-read command N_RD_CMD corresponding to LBA<1:10> has been processed.

The first core CORE_1 may determine that a portion of the normal-read command N_RD_CMD corresponding to the remaining ‘40’ logical block addresses ‘LBA<11:50>’ remains unprocessed. \textcircled{7} The first core CORE_1 may transmit the unprocessed ‘40’ normal-read commands N_RD_CMD to the memory device 150. \textcircled{8} The data DAT read from the memory device 150 may then be cached in the first cache RC_1. \textcircled{9} The first core CORE_1 may transmit the data DAT to the host 102.

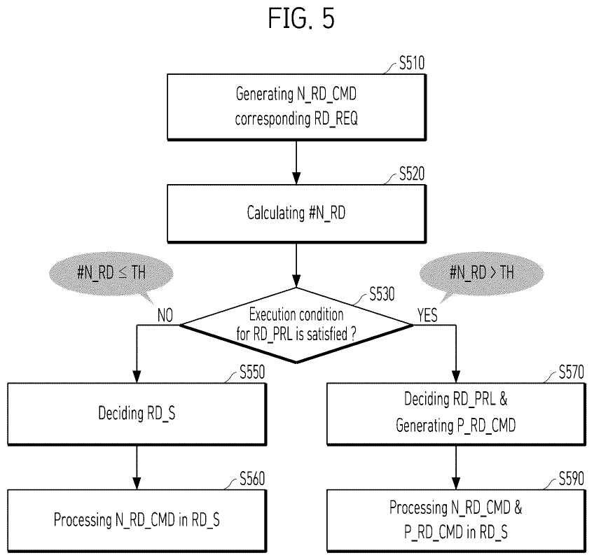

FIG. 5 is a flowchart illustrating a method by which a data storage system determines how to process a read operation, according to an embodiment of the disclosed technology.

In embodiments of the disclosed technology, the read operation may include a single-read operation RD_S and a parallel-read operation RD_PRL. The single-read operation RD_S refers to a read operation processed solely by one core. The parallel-read operation RD_PRL refers to a read operation processed in parallel by a plurality of cores. The read operation may be either a normal-read operation or a pre-read operation or the read operations may include a normal-read operation and a pre-read operation.

Referring to FIG. 5, in operation S510, the controller 130 may receive read requests RD_REQ for consecutive data from the host 102. The controller 130 may generate a plurality of normal-read commands N_RD_CMD.

In operation S520, the controller 130 may calculate an outstanding normal-command count #N_RD of unprocessed consecutive normal-read commands N_RD_CMD. The outstanding normal-command count #N_RD indicates the number of unprocessed consecutive normal-read commands stored in the queue QUE.

When the outstanding normal-command count #N_RD is large, the controller 130 may process the normal-read commands N_RD_CMD as a parallel-read operation RD_PRL, rather than a single-read operation RD_S, in order to reduce response time and read latency. The single-read operation RD_S may be performed by the first core CORE_1, while the parallel-read operation RD_PRL may be performed by both the first core CORE_1 and the second core CORE_2. In some implementations, in operation S530, the controller 130 may determine whether an execution condition for the parallel-read operation RD_PRL is satisfied, based on a comparison between the outstanding normal-command count #N_RD and a predetermined threshold count TH.

The outstanding normal-command count #N_RD not exceeding the threshold count TH (#N_RD≤TH) (NO in S530) indicates the recent read request pattern of the host 102 is non-consecutive. Thus, the controller 130 may determine that the execution condition of the parallel-read operation RD_PRL is not satisfied. Accordingly, the controller 130 may decide to process the normal-read commands N_RD_CMD as the single-read operation RD_S in S550. In operation S560, the controller 130 may control the first core CORE_1 to process the normal-read commands N_RD_CMD as the single-read operation RD_S.

If the outstanding normal-command count #N_RD exceeds the threshold count TH (i.e., #N_RD>TH, YES in S530), this indicates that the recent read request pattern of the host 102 is consecutive. In this case, the controller 130 may determine that the execution condition for the parallel-read operation RD_PRL is satisfied. Accordingly, the controller 130 may decide to process the normal-read commands N_RD_CMD as a parallel-read operation RD_PRL. Furthermore, in operation S570, the controller 130 may generate pre-read commands P_RD_CMD continuous to the normal-read commands N_RD_CMD and determine to process them in parallel using both the first core CORE_1 and the second core CORE_2. In operation S590, the controller 130 may control the two cores to perform the normal-read command N_RD_CMD and pre-read command P_RD_CMD as the parallel-read operation RD_PRL.

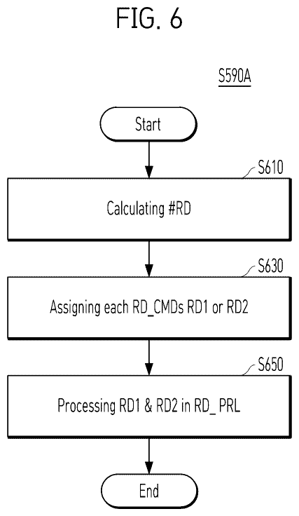

FIGS. 6 to 9B are example diagrams illustrating a method of processing a parallel-read operation according to a first embodiment of the disclosed technology. Hereinafter, the parallel-read operation according to the first embodiment will be described with reference to FIGS. 6 to 9B.

In operation S610, the controller 130 may calculate an outstanding read count #RD. The outstanding read count #RD indicates the number of unprocessed read commands including normal-read commands N_RD_CMD and pre-read commands P_RD_CMD, which are stored in the queue QUE.

In operation S630, the controller 130 may assign each of the unprocessed read commands RD_CMD to either a first command processing operation RD1 performed by the first core CORE_1, or a second command processing operation RD2 performed by the second core CORE_2. In one embodiment, the controller 130 may assign an equal number of read commands to each of the first and second command processing operations RD1 and RD2.

In operation S650, the controller 130 may process the unprocessed read commands assigned to the first command processing operation RD1 and the second command processing operation RD2 as a parallel-read operation RD_PRL.

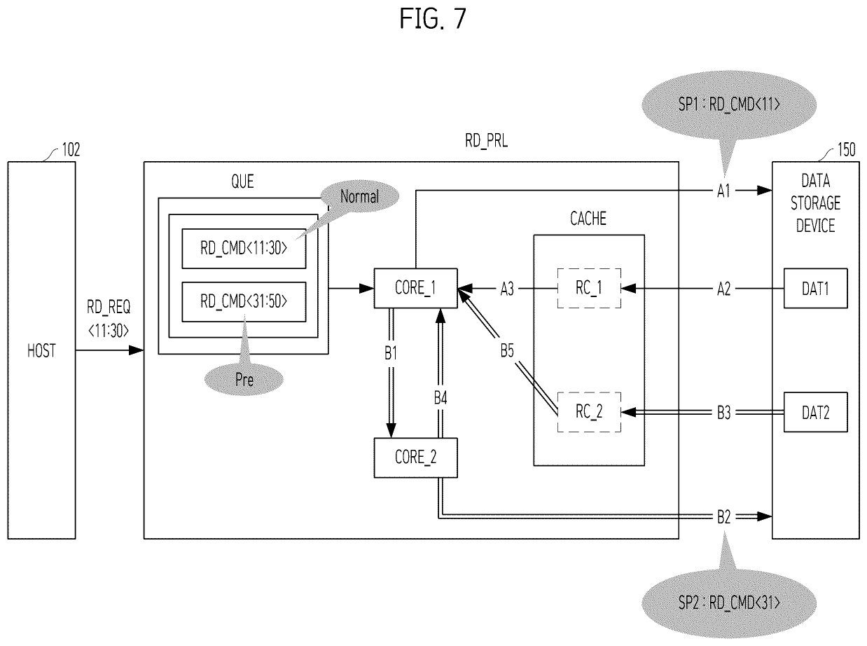

FIG. 7 illustrates an example of the parallel-read operation RD_PRL according to the first embodiment described in FIG. 6.

In the description of FIG. 7, portions overlapping with FIGS. 3 to 6 will be omitted.

The first core CORE_1 is a processor and may serve as a main-core which is selected by the host 102 or the controller 130 to process normal-read commands. The second core CORE_2 is another processor and may serve as a sub-core which is selected by the controller 130 to process normal-read commands. In this embodiment, the second core CORE_2 may perform the read operation under or based on the control of the first core CORE_1. In the embodiments of the present disclosure, the controller includes a main-core and a sub-core. The main-core is configured to act as a master core that controls the overall operation of the data storage device. The sub-core is configured to act as a slave core that performs operations under the control of the main-core. More specifically, the main-core issues commands and scheduling instructions to the sub-core. The sub-core executes the assigned operations, such as processing a portion of read commands or pre-read commands, based on the control signals or instructions received from the main-core. The main-core manages the synchronization and coordination between itself and the sub-core to ensure efficient parallel processing of read operations. The main-core may also monitor the operation status of the sub-core and adjust the task assignments dynamically depending on the workload and operational state of the sub-core. In this structure, the main-core and the sub-core collectively process read commands in a parallel manner, wherein the sub-core operates subordinate to the main-core's control to enhance the read efficiency and reduce the response time for host requests.

When read requests RD_REQ<11:30> for ‘20’ consecutive logical block addresses are received from the host 102, the first core CORE_1 may generate ‘20’ RD_CMD<11:30> and sort them in the queue QUE in the order of the requests. The RD_CMD<11:30> are normal-read commands. The outstanding normal-command count #N_RD is defined as the number of unprocessed consecutive normal-read commands. In this case, the outstanding normal-command count #N_RD is ‘20’ and exceeds the threshold count TH (e.g., TH=5). Accordingly, the first core CORE_1 may decide to process the read operation as a parallel-read operation RD_PRL. Furthermore, the first core CORE_1 may generate ‘20’ read commands RD_CMD<31:50> following the read commands RD_CMD<11:30> and store them in the queue QUE. The RD_CMD<31:50> are pre-read commands and consecutive to the normal-read commands RD_CMD<11:30>. While it is described above that the number of pre-read commands is 20, it is the example only. The number of pre-read commands generated may vary depending on the embodiment.

To process ‘40’ read commands RD_CMD<11:50> as a parallel-read operation RD_PRL, the first core CORE_1 may assign each of the read commands RD_CMD<11:50> to either the first command processing operation RD1 or the second command processing operation RD2. To equally divide the read commands RD_CMD<11:50> between the first command processing operation RD1 and the second command processing operation RD2, the first core CORE_1 may determine a first start point SP1 and a second start point SP2.

For example, the first core CORE_1 may designate the first sorted RD_CMD<11> as the first start point SP1 for the first command processing operation RD1. Similarly, the first core CORE_1 may designate the first sorted RD_CMD<31> as the second start point SP2 for the second command processing operation RD2.

In step A1, the first core CORE_1 may consecutively process the first command processing operation RD1 starting from RD_CMD<11> (SP1). In step A2, the first data DAT1 read from the memory device 150 may be cached in the first cache RC_1. The first data DAT1 may be normal-read data requested by the host 102. In step A3, the first core CORE_1 may read the cached first data DAT1 and then transmit the first data DAT1 to the host 102.

In step B1, the first core CORE_1 may request the second core CORE_2 to perform the second command processing operation RD2. In step B2, the second core CORE_2 may consecutively process the second command processing operation RD2 starting from RD_CMD<31> (SP2). In step B3, the second data DAT2 read from the memory device 150 may be cached in the second cache RC_2. In step B4, the second core CORE_2 may transmit a message to the first core CORE_1 indicating that the second data DAT2 has been cached. Based on the received message, the first core CORE_1 may determine that the second command processing operation RD2 has been completed. The second data DAT2 may be pre-read data that was not explicitly requested by the host 102.

In step B5, if a new read request (e.g., RD_REQ<31:50>) for the second data DAT2 is later received from the host 102, the first core CORE_1 may transmit the second data DAT2 from the second cache RC_2 to the host 102, instead of accessing the memory device 150.

In the parallel-read operation RD_PRL according to the first embodiment of the disclosed technology, if operating speeds of the first core CORE_1 and the second core CORE_2 are the same, the first command processing operation RD1 and the second command processing operation RD2 may be started and completed almost simultaneously. Therefore, the read commands RD_CMD<11:50> may be processed faster by the parallel read RD_PRL of the first and second cores CORE_1 and CORE_2 than by the single read RD_S of the first core CORE_1.

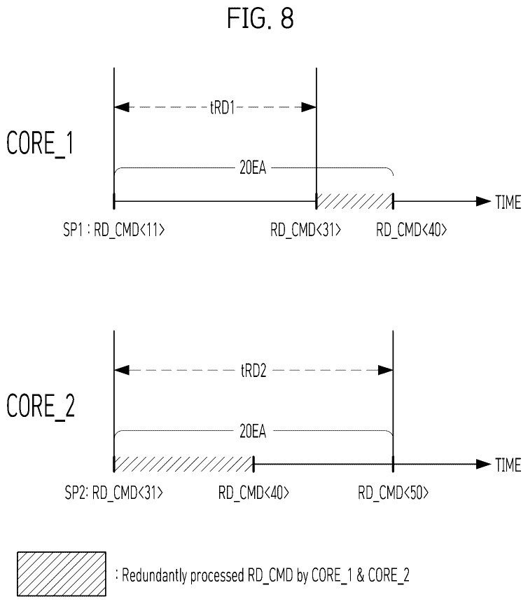

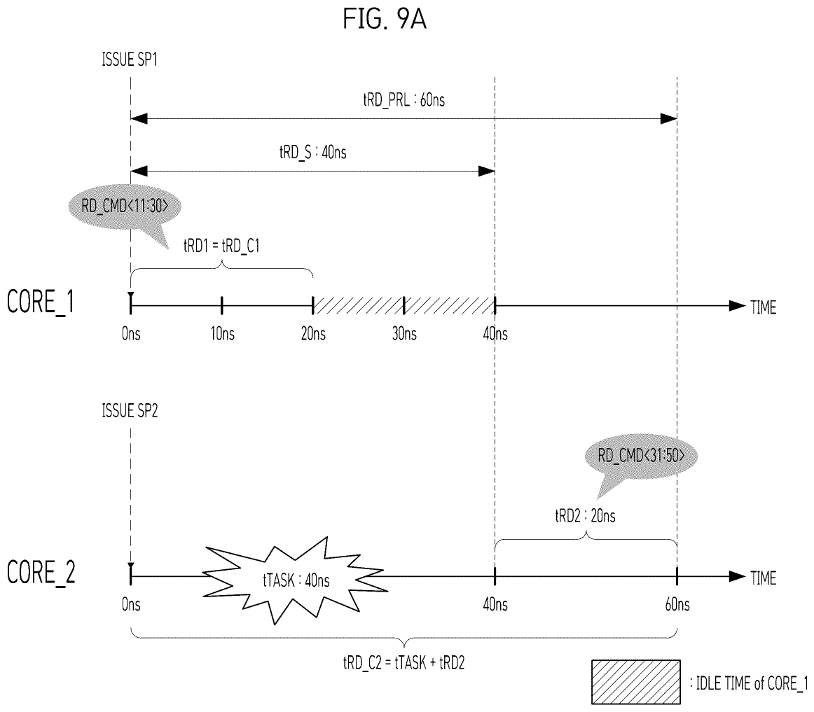

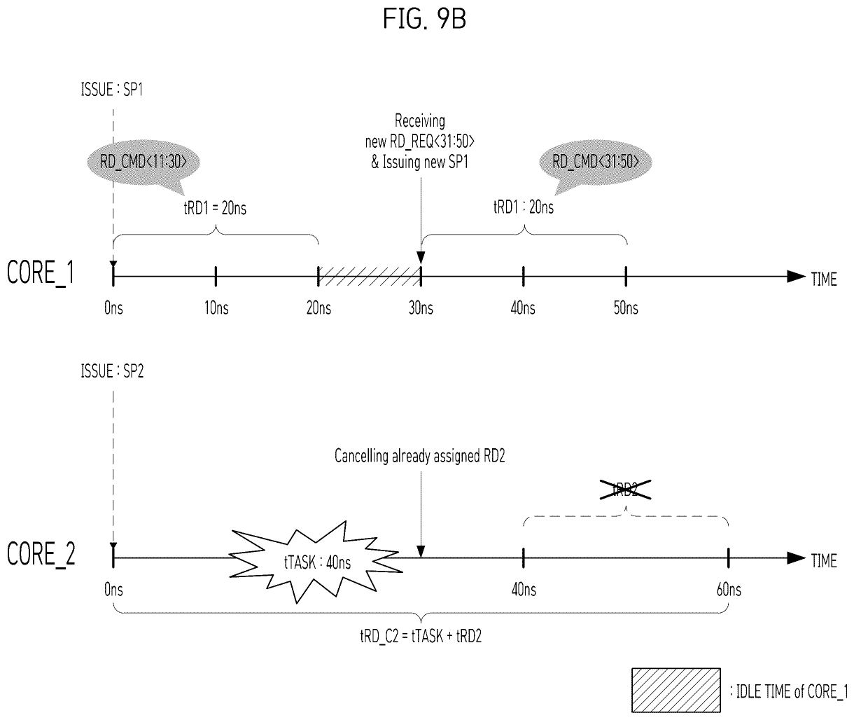

FIGS. 8 to 9B describe diagrams illustrating potential issues that may occur during the execution of the parallel-read operation RD_PRL according to the first embodiment of the disclosed technology.

Among the read commands RD_CMD<11:50> stored in the queue QUE, RD_CMD<11:30> may be normal-read commands, and RD_CMD<31:50> may be pre-read commands. The first core CORE_1 may determine that the operating speed of the second core CORE_2 is equal to that of the first core CORE_1. The first core CORE_1 may assign RD_CMD<11> as the first start point SP1 for the ‘20’ normal-read commands RD_CMD<11:30> to be processed as the first command processing operation RD1. The first core CORE_1 may also assign RD_CMD<31> as the second start point SP2 for the ‘20’ pre-read commands RD_CMD<31:50> to be processed as the second command processing operation RD2.

While the second core CORE_2 sequentially processes the ‘20’ read commands RD_CMD<31:50> from the second start point SP2, the first core CORE_1 is expected to process only the ‘20’ read commands RD_CMD<11:30> from the first start point SP1.

However, in practice, the operating speed of the first core CORE_1 may be higher than that of the second core CORE_2. As a result, the number of commands processed by the first core CORE_1 may exceed those processed by the second core CORE_2 within the same time period. FIG. 8 illustrates a CASE in which the cores operate at different speeds.

As shown in FIG. 8, during the second command processing operation time tRD2, when the second core CORE_2 processes RD_CMD<31:50>, the first core CORE_1 may process thirty commands RD_CMD<11:40>, exceeding its expected ‘20’.

In this case, the ‘10’ read commands RD_CMD<31:40> indicated by hatching may be redundantly processed by both the first core CORE_1 and the second core CORE_2. As a result, the same data may be redundantly stored in both the first cache RC_1 and the second cache RC_2, and the storage space of the cache memory CACHE may be used inefficiently. Additionally, due to this redundancy, the processing resources of both cores may be wasted.

FIGS. 9A and 9B illustrate a situation where, despite the cores operating at the same speed, delays occur due to a prior task assigned to the second core CORE_2 before starting the second command processing operation RD2.

A first command processing operation time tRD1 refers to the time taken from when the first core CORE_1 begins processing the first read command RD_CMD<11> to when the first core CORE_1 completes processing the last read command RD_CMD<30>, while among all commands, RD_CMD<11:30> is assigned to the first core CORE_1. A first command processing completion time tRD__{C1} refers to the time taken from when the first command processing operation RD1 is assigned to when the first core CORE_1 completes processing the last read command included in the first command processing operation RD1. A second command processing operation time tRD2 refers to the time taken from when the second core CORE_2 begins processing the first read command RD_CMD<31> to when the second core CORE_2 completes processing the last read command RD_CMD<50>, while among all commands, RD_CMD<31:50> is assigned to the second core CORE_2. A second command processing completion time tRD_C2 refers to the time taken from when the second command processing operation RD2 is assigned to when the second core CORE_2 completes processing the last read command included in the second command processing operation RD2. As shown in FIG. 9A, both the first command processing operation time tRD1 and the second command processing operation time tRD2 are indicated as ‘20 ns’.

However, if the second core CORE_2 has a prior task TASK before the second command processing operation RD2, the second core CORE_2 needs to complete the prior task TASK first before performing the second command processing operation RD2. Thus, even after the first core CORE_1 completes the first command processing operation RD1, if the second core CORE_2 has not finished the prior task TASK, the second command processing operation RD2 may not start. Therefore, even after the first command processing operation RD1 is completed, the second command processing operation RD2 may not be completed. In this case, the first command processing operation RD1 and the second command processing operation RD2 may not begin and end simultaneously.

Since the first core CORE_1 has no task prior to the first command processing operation RD1, the first core CORE_1 may begin the first command processing operation RD1 immediately upon assignment, corresponding to SP1 at ‘0 ns’. The processing is completed at ‘20 ns’, so the first command processing completion time tRD__{C1} is ‘20 ns’, which is equal to the first command processing operation time tRD1.

The second core CORE_2 serves as the sub-core controlled by the first core CORE_1. The second command processing operation time tRD2 is defined as the time taken by the second core CORE_2 to process only the second command processing operation RD2. As shown in FIG. 9A, the second command processing operation time tRD2 may be ‘20 ns’ (from ‘40 ns’ to ‘60 ns’). However, the second core CORE_2 cannot start the second command processing operation RD2 at ‘0 ns’ due to TASK. Even after the first core CORE_1 completes the first command processing operation RD1 at ‘20 ns’, the second command processing operation RD2 has not yet begun. The second core CORE_2 may only begin the second command processing operation RD2 after completing TASK at ‘40 ns’.

Since the second command processing operation RD2 is not assigned to the first core CORE_1, the first core CORE_1 cannot perform the second command processing operation RD2 even during the idle time indicated by the hatching. Therefore, the first core CORE_1 must wait until the second core CORE_2 completes the second command processing operation RD2 at ‘60 ns’.

In FIG. 9A, the second command processing completion time tRD_C2 of the second core CORE_2 may be ‘60 ns’, which is the sum of the tTASK (‘40 ns’) and the tRD2 (‘20 ns’). In other words, the second command processing completion time tRD_C2 spans from ‘0 ns’ to ‘60 ns’.

The parallel-read time tRD_PRL, which is the total time taken by the first core CORE_1 and the second core CORE_2 to process the ‘40’ read commands RD_CMD<11:50> using the parallel-read operation RD_PRL, may be ‘60 ns’. At this time, the parallel-read time tRD_PRL is determined as the greater of the first command processing completion time tRD__{C1} and the second command processing completion time tRD_C2. That is, the parallel-read time tRD_PRL is ‘60 ns’.

A first unit time tUNIT__{C1} taken by the first core CORE_1 to process a single read command may be ‘1 ns’. If the first core CORE_1 processes the ‘40’ read commands RD_CMD<11:50> using the single-read operation RD_S, the single-read time tRD_S may be ‘40 ns’. In this case, the parallel-read time tRD_PRL may be longer than the single-read time tRD_S.

FIG. 9B illustrates a CASE in which a new read request corresponding to the second command processing operation RD2 is received from the host 102 before the second core CORE_2 starts the second command processing operation RD2.

As illustrated in FIG. 9B, a new read request RD_REQ<31:50> may be received from the host 102 at ‘30 ns’, after the first and second command processing operations RD1 and RD2 are assigned at ‘0 ns’.

The first core CORE_1 may recognize that the pre-read commands RD_CMD<31:50>, which are already assigned to the second command processing operation RD2, correspond to a new read request RD_REQ<31:50>. If the second core CORE_2 has not yet started the second command processing operation RD2 for RD_CMD<31:50> at the time the new read request RD_REQ<31:50> is received by the first core CORE_1, the first core CORE_1 may cancel the assignment of the second command processing operation RD2 to the second core CORE_2. Then, the first core CORE_1 may reassign RD_CMD<31:50> to the first command processing operation RD1. In one embodiment, the first core CORE_1 may cancel the assignment of the second command processing operation RD2 to the second core CORE_2 only when it is confirmed that the second core CORE_2 has not yet begun executing the second command processing operation RD2. In some implementations, the controller 130 may perform a synchronization check using a flag or a status signal that indicates whether the second core CORE_2 has entered the execution state for the second command processing operation RD2. This ensures that the second command processing operation RD2 is reassigned to the first core CORE_1 without causing data inconsistency or command duplication.

The first core CORE_1 previously processed ‘20’ read commands RD_CMD<11:30> during 20 ns (from 0 ns to 20 ns). Therefore, the first core CORE_1 may determine that one read command can be processed during ‘1 ns’. The time of ‘1 ns’ taken to process a single read command is defined as the first processing unit time tUNIT__{C1} of the first core CORE_1. Accordingly, the time required for the first core CORE_1 to complete processing the ‘20’ read commands RD_CMD<31:50> corresponding to the new read request RD_REQ<31:50> is ‘20 ns’. The first core CORE_1 may then transmit data corresponding to RD_REQ<31:50> to the host 102 at ‘50 ns’. At this time, since the data is read from the data storage device 150, not from the cache memory CACHE, the response time for RD_REQ<31:50> is ‘20 ns’.

If the ‘40’ read commands RD_CMD<11:50> were processed using the single-read operation RD_S instead of the parallel-read operation RD_PRL, RD_CMD<31:50> corresponding to the pre-read commands could have been processed during the time indicated by diagonal hatching. That is, since RD_CMD<31:50> would have been processed before the corresponding read request RD_REQ<31:50> was received from the host 102, the response time for RD_REQ<31:50> would have been ‘10 ns’.

To address the issues described in FIGS. 8 to 9B, the parallel-read operation RD_PRL according to a second embodiment of the disclosed technology is configured to perform the parallel-read operation RD_PRL by taking into account the operating speeds of the first core CORE_1 and the second core CORE_2, as well as their command processing capabilities based on workload (e.g., TASK).

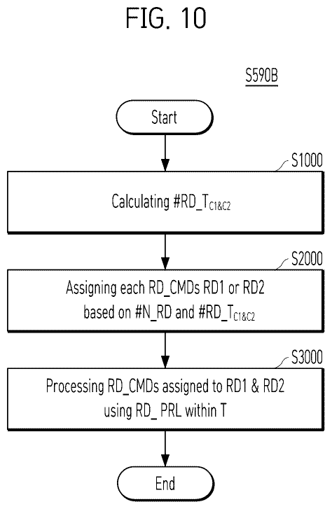

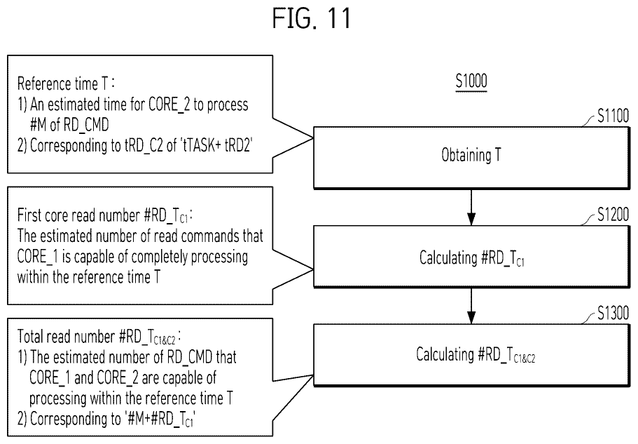

Hereinafter, a parallel-read operation RD_PRL according to a second embodiment of the disclosed technology will be described with reference to FIGS. 10 to 13. Embodiments of the disclosed technology may provide a data storage system and an operating method of the data storage system that control the plurality of cores to efficiently process the parallel-read operation. In addition, embodiments of the disclosed technology may provide a data storage system and an operating method that may minimize the response time for the read request received from the host. Furthermore, embodiments of the disclosed technology may provide a data storage system and an operating method that may efficiently process the parallel-read by considering the workload and operating speed of the plurality of cores that process the parallel-read.

FIG. 10 is a flowchart illustrating a method of processing a parallel-read operation RD_PRL according to a second embodiment of the disclosed technology.

More specifically, FIG. 10 illustrates a method for determining the command processing capabilities of the first core CORE_1 and the second core CORE_2 based on their respective operating speeds and workloads. It also illustrates a method for assigning unprocessed read commands to the first command processing operation RD1 and the second command processing operation RD2 according to the determined command processing capabilities. Here, the read commands may include both normal-read commands and pre-read commands.

In operation S1000, the controller 130 may calculate a read command number #RD_T_{C1&C2}. The read command number #RD_T_{C1&C2} indicates the estimated number of read commands RD_CMD that the first core CORE_1 and the second core CORE_2 can collectively process within a reference time T. Thus, the read command number #RD_T_{C1&C2} represents the number of read commands RD_CMD, including at least one of the normal-read commands N_RD_CMD and the pre-read commands P_RD_CMD, which are processable by the controller 130 within the reference time T. The read command number #RD_T_{C1&C2} may correspond to the combined command processing capability of the first core CORE_1 and the second core CORE_2. In the present description, the reference time T refers to an estimated time required for the second core CORE_2, which serves as the sub-core, to process #M of read commands RD_CMD. The reference count #M may correspond to the size of the second cache RC_2 assigned to the second core CORE_2. Alternatively, the reference count #M may correspond to the size of a data segment, which represents a unit of data transmitted to the host 102 at one time. In other words, the second core CORE_2 may process the #M read commands RD_CMD within the reference time T. The controller 130 may also calculate a first core read number #RD_T_{C1}. The first core read number #RD_T_{C1} indicates the estimated number of read commands that the first core CORE_1, serving as the main-core, can process within the reference time T. Accordingly, as shown in Equation 1 below, the read command number #RD_T_{C1&C2} may be obtained by summing the first core read number #RD_T_{C1} and the reference count #M.

#RD_T_{C1&C2}=#RD_T_{C1}+#M Equation 1:

For example, assume that the second core CORE_2 takes ‘40 ns’ to process ‘5’ read commands, and the first core CORE_1 can process ‘15’ read commands within the same ‘40 ns’. In this case, the first core CORE_1 and the second core CORE_2 can collectively process ‘20’ read commands within ‘40 ns’. Accordingly, the reference count #M may be ‘5’, the reference time T may be ‘40 ns’, the first core read number #RD_T_{C1} may be 15, and the read command number #RD_T_{C1&C2} may be 20.

Therefore, the controller 130 may determine the command processing capabilities of the first core CORE_1 and the second core CORE_2 based on their workloads and operating speeds, using the read command number #RD_T_{C1&C2}.

In operation S2000, the controller 130 may assign each of the read commands RD_CMD stored in the queue QUE of FIG. 7 to at least one of the first command processing operation RD1 and the second command processing operation RD2, based on a comparison result between the outstanding normal-command count #N_RD and the read command number #RD_T_{C1&C2}. The first command processing operation RD1 is to be performed by the first core CORE_1, and the second command processing operation RD2 is to be performed by the second core CORE_2. The outstanding normal-command count #N_RD is the number of unprocessed consecutive normal-read commands.

In operation S3000, the controller 130 may process the read commands RD_CMD assigned to the first command processing operation RD1 and the second command processing operation RD2 in parallel, using the parallel-read operation RD_PRL, within the reference time T.

FIG. 11 illustrates in detail the calculation operation S1000 of the read command number #RD_T_{C1&C2}, as described in FIG. 10.

In operation S1100, the controller 130 may obtain the reference time T required for the second core CORE_2 to complete processing the #M read commands RD_CMD. The reference time T is an estimated time and may correspond to the second command processing completion time tRD_C2 illustrated in FIGS. 9A and 9B. Thus, the reference time T may be the sum of the second command processing operation time tRD2 and the task processing time tTASK. The second command processing operation time tRD2 refers to the time taken by the second core CORE_2 to process the #M read commands RD_CMD, and the task processing time tTASK refers to the time required for the second core CORE_2 to complete a task TASK that must be performed prior to the #M read commands RD_CMD.

The controller 130 may obtain the reference time T based on historical information regarding tasks and read commands previously processed by the second core CORE_2. Additionally, the controller 130 may obtain the reference time T by querying the second core CORE_2

The reference count #M may correspond to a size of the second cache RC_2 assigned to the second core CORE_2. For example, if one piece of data is read through one read operation, and the size of the second cache RC_2 corresponds to ‘5’ data pieces, the reference count #M may be ‘5’.

Additionally, the reference count #M may correspond to the size of a “data segment,” which is a unit of data transmitted to the host 102 at one time. For example, if the data segment includes ‘5’ data pieces, the reference count #M may be ‘5’.

If the reference count #M is ‘5’ and the reference time T is ‘40 ns’, the second core CORE_2 may guarantee completion of processing the ‘5’ read commands within ‘40 ns’. That is, even when a task TASK is assigned prior to the ‘5’ read commands, the second core CORE_2 may still guarantee completion of the ‘5’ read commands within ‘40 ns’. Accordingly, the controller 130 may determine the command processing capability of the second core CORE_2 based on the workload and operating speed, using the reference count #M and the reference time T.

In operation S1200, the controller 130 may calculate the first core read number #RD_T_{C1}, which is the number of read commands that the first core CORE_1 is capable of completely processing within the reference time T. Here, the reference time T is the time required for the second core CORE_2 to process the #M read commands RD_CMD.

For example, if the reference time T is ‘40 ns’ and the calculated first core read number #RD_T_{C1} is ‘10’, the first core CORE_1 may guarantee completion of processing ‘10’ read commands within ‘40 ns’. Accordingly, the controller 130 may determine the command processing capability of the first core CORE_1 based on the first core read number #RD_T_{C1}.

In operation S1300, the controller 130 may calculate the read command number #RD_T_{C1&C2} by summing the reference count #M and the first core read number #RD_T_{C1}. The read command number #RD_T_{C1&C2} is defined as the estimated number of read commands that are capable of being processed by both the first core CORE_1 and the second core CORE_2 within the reference time T.

Through operations S1100 to S1300, the controller 130 may determine the first core read number #RD_T_{C1}, during which the second core CORE_2 completes processing the #M read commands. That is, the controller 130 may calculate the read command number #RD_T_{C1&C2}.

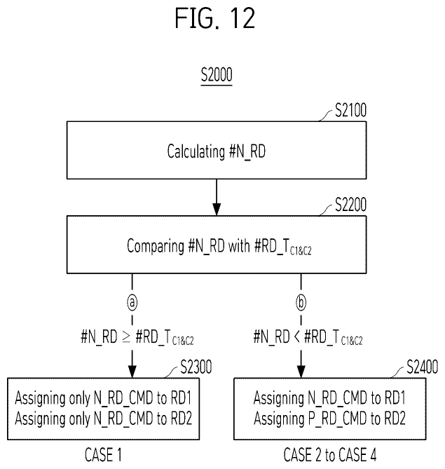

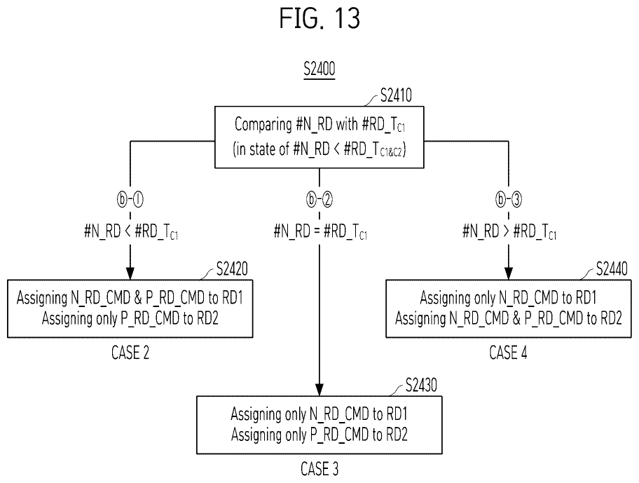

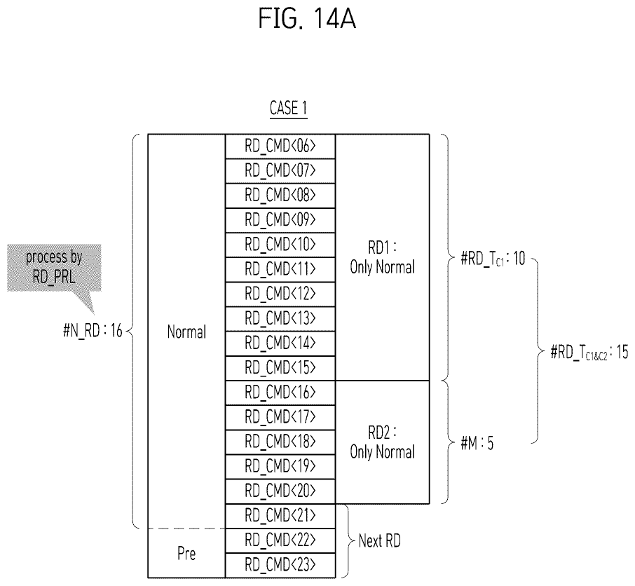

Hereinafter, the assigning operation S2000 of read commands to the first command processing operation RD1 and the second command processing operation RD2, as described in FIG. 10, will be explained with reference to FIGS. 12 and 13. In particular, FIG. 12 illustrates a method of assigning commands to promptly process unprocessed normal-read commands in order to reduce the response time to a read request.

In operation S2100, the controller 130 may calculate the outstanding normal-command count #N_RD of normal-read commands among the unprocessed read commands.

In operation S2200, the controller 130 may compare the calculated outstanding normal-command count #N_RD with the read command number #RD_T_{C1&C2}. To this end, the controller 130 may determine whether the outstanding normal-command count #N_RD is less than the read command number #RD_T_{C1&C2}.

Operations S2300 and S2400 in FIG. 12 illustrate the assignment of read commands to the first command processing operation RD1 and the second command processing operation RD2, which are performed in the parallel-read operation RD_PRL within the reference time T.

As a result of the comparison \textcircled{a} of the operation S2200, when the outstanding normal-command count #N_RD is greater than or equal to the read command number #RD_T_{C1&C2} (i.e., #N_RD #RD_T_{C1&C2}), the controller 130 may determine that the outstanding normal-command count #N_RD is relatively large. Accordingly, the controller 130 may assign the normal-read commands N_RD_CMD to both the first command processing operation RD1 and the second command processing operation RD2, so that the normal-read commands N_RD_CMD are processed as much as possible within the reference time T, in operation S2300. This corresponds to CASE 1.

As a result of the comparison \textcircled{b} of the operation S2200, when the outstanding normal-command count #N_RD is less than the read command number #RD_T_{C1&C2} (i.e., #N_RD<#RD_T_{C1&C2}), the controller 130 may determine that the outstanding normal-command count #N_RD is relatively small. Accordingly, in operation S2400, the controller 130 may assign not only the normal-read commands N_RD_CMD but also the pre-read commands P_RD_CMD to be processed within the reference time T. Thus, the controller 130 may assign the normal-read commands N_RD_CMD to the first command processing operation RD1 and the pre-read commands P_RD_CMD to the second command processing operation RD2. In other words, since the outstanding normal-command count #N_RD is relatively small and can be entirely handled by the first core CORE_1, the remaining command processing capability of the second core CORE_2 within the reference time T can be utilized to prefetch data through the pre-read commands. Distributing the pre-read commands to both the first core CORE_1 and the second core CORE_2 enables parallel caching of sequential data blocks that are likely to be requested in the near future, thereby improving overall data throughput and minimizing average read latency. These correspond to CASE 2 to CASE 4.

The number of read commands assigned to the first command processing operation RD1 may be the first core read number #RD_T_{C1}, and the number of read commands assigned to the second command processing operation RD2 may be the reference count #M. That is, the number “#RD_T_{C1}+#M” of the read commands may be processed in the parallel-read mode RD_PRL within the reference time T. Accordingly, the response time to the read request RD_REQ already received from the host 102 may be minimized.

Additionally, based on the comparison result of the outstanding normal-command count #N_RD and the first core read number #RD_T_{C1}, the controller 130 may additionally assign the pre-read commands P_RD_CMD to the first command processing operation RD1 or may additionally assign the normal-read commands N_RD_CMD to the second command processing operation RD2. Alternatively, based on the comparison result, the controller 130 may choose not to assign either the pre-read commands P_RD_CMD or the normal-read commands N_RD_CMD. This will be described in further detail with reference to FIG. 13.

FIG. 13 illustrates in detail operation S2400 in FIG. 12, which corresponds to CASE 2 through CASE 4

In a state where the outstanding normal-command count #N_RD is less than the read command number #RD_T_{C1&C2} (i.e., #N_RD<#RD_T_{C1&C2}), the controller 130 may compare the outstanding normal-command count #N_RD with the first core read number #RD_T_{C1} in operation S2410. The first core read number #RD_T_{C1} indicates the number of read commands that the first core CORE_1 can completely process within the reference time T. The read command number #RD_T_{C1&C2} indicates the estimated number of read commands that the first core CORE_1 and the second core CORE_2 can completely process within the reference time T.

As a result of comparison \textcircled{b}-\textcircled{1} of the operation S2410, when the outstanding normal-command count #N_RD is less than the first core read number #RD_T_{C1}, the controller 130 may recognize this case as CASE 2 (#N_RD<#RD_T_{C1&C2} and #N_RD<#RD_T_{C1}). The controller 130 determines that the first core CORE_1 can process all the unprocessed normal-read commands stored in the queue within the reference time T and also has the capacity to process additional read commands. Accordingly, in operation S2420, the controller 130 assigns all the normal-read commands N_RD_CMD to the first command processing operation RD1 and assigns the pre-read commands P_RD_CMD to both the first and second command processing operations RD1 and RD2. As a result, the pre-read commands P_RD_CMD are processed in parallel by the first command processing operation RD1 and the second command processing operation RD2. At this time, the sum of the number of normal-read commands N_RD_CMD and pre-read commands P_RD_CMD assigned to the first command processing operation RD1 may be the first core read number #RD_T_{C1}. The number of pre-read commands P_RD_CMD assigned to the second command processing operation RD2 may be the reference count #M.

As a result of comparison \textcircled{b}-\textcircled{2} of the operation S2410, when the outstanding normal-command count #N_RD is equal to the first core read number #RD_T_{C1}, the controller 130 may recognize this case as CASE 3 (i.e., #N_RD<#RD_T_{C1&C2} and #N_RD=#RD_T_{C1}). The controller 130 determines that the first core CORE_1 can process only as many unprocessed normal-read commands as are stored in the queue within the reference time T. Accordingly, in operation S2430, the controller 130 assigns only the normal-read commands N_RD_CMD to the first command processing operation RD1 and assigns only the pre-read commands P_RD_CMD to the second command processing operation RD2. At this time, the number of normal-read commands N_RD_CMD assigned to the first command processing operation RD1 may be the first core read number #RD_T_{C1}, and the number of pre-read commands P_RD_CMD assigned to the second command processing operation RD2 may be the reference count #M.

As a result of comparison \textcircled{b}-\textcircled{3} of the operation S2410, when the outstanding normal-command count #N_RD is greater than the first core read number #RD_T_{C1}, the controller 130 may recognize this case as CASE 4 (i.e., #N_RD<#RD_T_{C1&C2} and #N_RD>#RD_T_{C1}). The controller 130 determines that the first core CORE_1 cannot process all unprocessed normal-read commands stored in the queue within the reference time T. Accordingly, in operation S2440, the controller 130 assigns a portion of the normal-read commands N_RD_CMD to the first command processing operation RD1, and additionally assigns the remaining normal-read commands N_RD_CMD to the second command processing operation RD2. As a result, the normal-read commands N_RD_CMD are assigned to both the first and second command processing operations RD1 and RD2 to be processed in parallel. The pre-read commands P_RD_CMD are also assigned to the second command processing operation RD2. At this time, the number of normal-read commands N_RD_CMD assigned to the first command processing operation RD1 may be the first core read number #RD_T_{C1}, and the sum of the number of normal-read commands N_RD_CMD and pre-read commands P_RD_CMD assigned to the second command processing operation RD2 may be the reference count #M.

The first cache RC_1 assigned to the first core CORE_1 may include a normal cache and a pre-cache. The second cache RC_2 assigned to the second core CORE_2 may also include a normal cache and a pre-cache. The normal cache stores normal-read data, and the pre-cache stores pre-read data. DMA (Direct Memory Access) may be activated between the pre-cache included in each of the first and second caches RC_1 and RC_2 and the host 102. Accordingly, even if the host 102 does not transmit a separate read request to the data storage system 110, the pre-read data stored in the pre-cache may be directly accessed by the host 102.

If the second data DAT2 stored in the second cache RC_2 is to be transmitted to another data storage device, the reference count #M may correspond to a multiple of the size of the second cache RC_2 or a multiple of the size of a data segment. The other data storage device may include a working memory (not shown) of the host 102, the working memory 144, or the memory device 150 illustrated in FIG. 1.

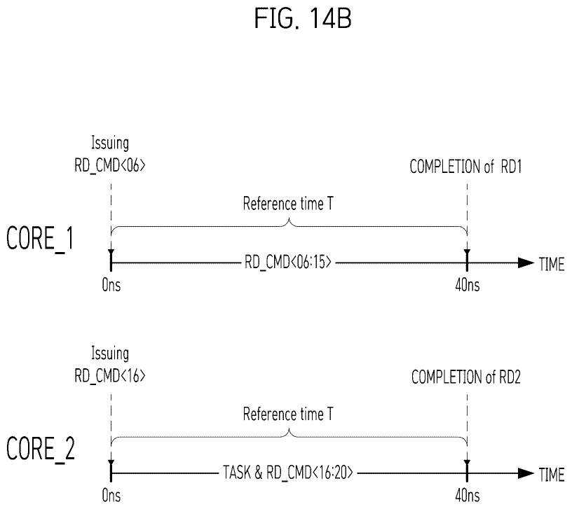

Hereinafter, with reference to FIGS. 14A to 17, an example will be described in which the read commands of the disclosed technology are assigned to the first and second command processing operations RD1 and RD2.

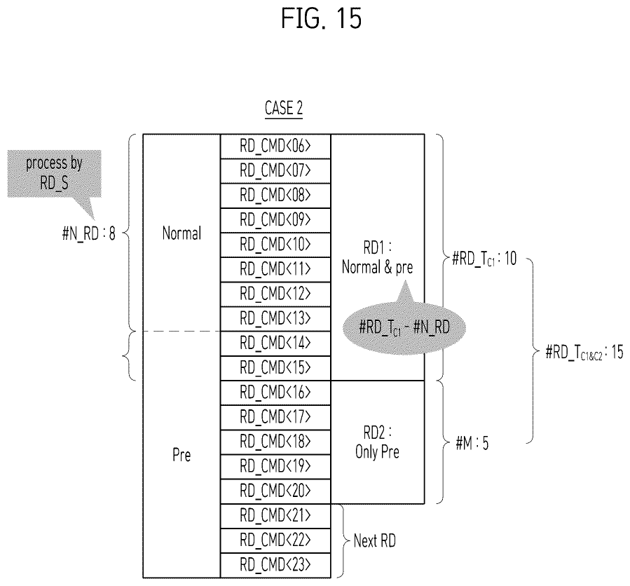

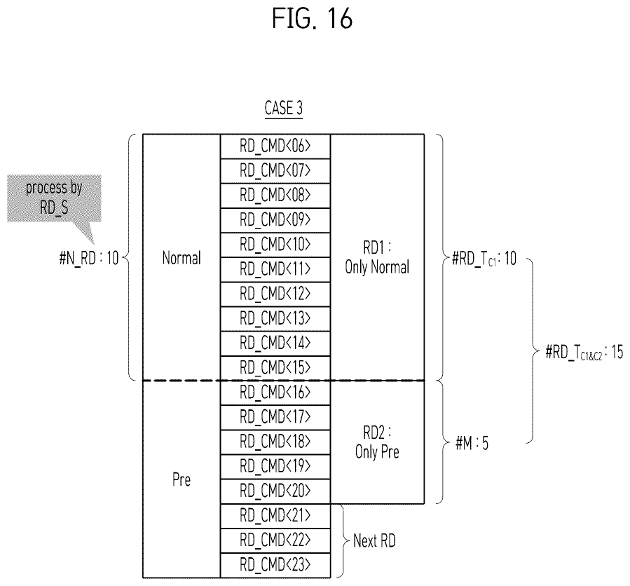

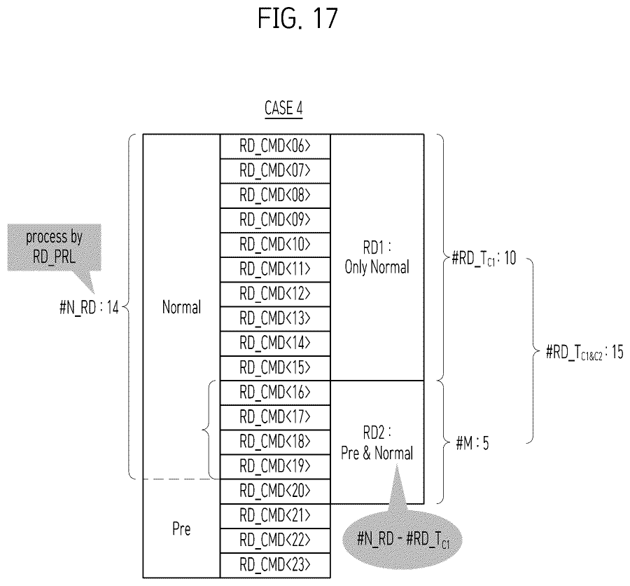

FIGS. 14A and 14B illustrate an example of CASE 1 in operation S2300 of FIG. 12. FIG. 15 illustrates an example of CASE 2 in operation S2420 of FIG. 13. FIG. 16 illustrates an example of CASE 3 in operation S2430 of FIG. 13. FIG. 17 illustrates an example of CASE 4 in operation S2440 of FIG. 13.

As shown in FIGS. 14A to 17, the first core CORE_1, which serves as the main-core for unprocessed read commands RD_CMD, performs a portion of the operations of the controller 130 as described in FIGS. 10 to 13.

Table 1 below shows 18 unprocessed read commands RD_CMD<06:23> as illustrated in FIGS. 14A to 17. Referring to Table 1: the reference count #M is ‘5’, and T is ‘40 ns’; that is, the reference time T required for the second core CORE_2 to process ‘5’ read commands is ‘40 ns’. The first core read number #RD_T_{C1} is ‘10’, meaning that the first core CORE_1 can process ‘10’ read commands within the reference time T, which is ‘40 ns’. The read command number #RD_T_{C1&C2} is ‘15’, indicating that the first core CORE_1 and the second core CORE_2, when operating in parallel, can process a total of ‘15’ read commands RD_CMD within the reference time T.

TABLE 1

| | | |
|---|---|---|
| #M | 5 | T = 40 ns |
| #RD_T_{C1} | 10 | |
| #RD_T_{C1&C2} | 15 | |

Hereinafter, a specific example of the parallel-read operation RD_PRL according to the second embodiment of the disclosed technology, under the conditions described in Table 1, will be described.

FIG. 14A illustrates a specific example of a method for assigning a plurality of unprocessed read commands RD_CMD<06:23> to the first command processing operation RD1 and the second command processing operation RD2. FIG. 14B illustrates an example in which the first and second command processing operations RD1 and RD2 assigned in FIG. 14A are performed as a parallel-read operation RD_PRL.

As illustrated in FIG. 14A, the read commands RD_CMD<06:21> are normal-read commands, and the read commands RD_CMD<22:23> are pre-read commands among the unprocessed read commands RD_CMD<06:23>. The first core CORE_1 calculates the outstanding normal-command count #N_RD from RD_CMD<06:21>, which corresponds to operation S2100 in FIG. 12. In this case, since the read commands RD_CMD<06:21> are unprocessed, the outstanding normal-command count #N_RD is ‘16’.

The first core CORE_1 compares the outstanding normal-command count #N_RD with the read command number #RD_T_{C1&C2}, which corresponds to operation S2200 in FIG. 12. Referring to Table 1, the read command number #RD_T_{C1&C2} is ‘15’.

As a result of the comparison, since the outstanding normal-command count #N_RD is greater than or equal to the read command number #RD_T_{C1&C2}, the first core CORE_1 may assign ‘15’ normal-read commands RD_CMD<06:20> to both the first command processing operation RD1 and the second command processing operation RD2. Specifically, the first core CORE_1 assigns ‘10’ read commands RD_CMD<06:15> in sorted order to the first command processing operation RD1, to be processed by the first core CORE_1. The remaining ‘5’ read commands RD_CMD<16:20> are assigned to the second command processing operation RD2, to be processed by the second core CORE_2. In one embodiment, even when only the first and second start points SP1 and SP2 of each read operation RD1 and RD2 are provided, the controller 130 may internally associate the subsequent read commands, arranged in contiguous order in the queue, with the respective start points. Accordingly, the memory device 150 may perform consecutive read operations based on the first and second start points SP1 and SP2 and the corresponding command ranges managed by the controller 130.

In this way, the first core CORE_1, according to the second embodiment of the disclosed technology, assigns only #M read commands to the second command processing operation RD2, where the reference count #M is ‘5’. The first core CORE_1 also assigns only #RD_T_{C1} read commands to the first command processing operation RD1, where the first core read number #RD_T_{C1} is ‘10’. Accordingly, the number of read commands RD_CMD assigned to each of the first and second command processing operations RD1 and RD2 may be determined based on the workload and read capabilities of the first and second cores CORE_1 and CORE_2.

As illustrated in FIG. 14B, the first core CORE_1 may transmit the first read commands RD_CMD<06:15>, assigned to the first command processing operation RD1, to the memory device 150. At the same time, the first core CORE_1 may transmit the second read commands RD_CMD<16:20>, assigned to the second command processing operation RD2, to the second core CORE_2. That is, the first core CORE_1 and the second core CORE_2 may control the memory device 150 to process ‘15’ normal-read commands RD_CMD<06:20> as a parallel-read operation RD_PRL within ‘40 ns’, which corresponds to the reference time T. Here, ‘15’ is the sum of the first core read number #RD_T_{C1} and the reference count #M.

At this time, the read command RD1_CMD may not include all physical addresses corresponding to the first command processing operation RD1; instead, it may include only the physical address corresponding to RD_CMD<06>, which is the starting point of RD1. Similarly, the read command RD2_CMD may include only the physical address corresponding to RD_CMD<16>, which is the starting point of the second command processing operation RD2.

The first and second command processing operations RD1 and RD2 are determined based on the workload and read time of the first core CORE_1 and the second core CORE_2. Accordingly, even if the read commands RD1_CMD and RD2_CMD include only the physical addresses of their respective starting points, the parallel-read operation RD_PRL does not process overlapping read commands. In other words, the parallel-read operation RD_PRL avoids redundant command execution and may be performed without idle time.

Even if the operating speeds of the first core CORE_1 and the second core CORE_2 are different, the first and second command processing operations RD1 and RD2 may still be completed simultaneously as the parallel-read operation RD_PRL. Even when the second core CORE_2 has a task to complete before starting the second command processing operation RD2, the first and second command processing operations RD1 and RD2 may be completed simultaneously as the parallel-read operation RD_PRL without delay. After completing the parallel-read operation RD_PRL, the first core CORE_1 may return to step S520 of FIG. 5 to process the remaining three commands RD_CMD<21 to 23> as the next read operation, which were not processed during the parallel-read.

FIG. 15 illustrates an example of CASE 2, as described in step S2420 of FIG. 13. Portions overlapping with FIGS. 14A and 14B are omitted from the following description.

As illustrated in FIG. 15A, the read commands RD_CMD<06:13> are normal-read commands, and the read commands RD_CMD<14:23> are pre-read commands among the unprocessed read commands RD_CMD<06:23>. The first core CORE_1 may calculate the outstanding normal-command count #N_RD, where #N_RD is ‘8’.

The first core CORE_1 may compare the outstanding normal-command count #N_RD with the read command number #RD_T_{C1&C2}. In this case, the outstanding normal-command count #N_RD is ‘8’, and the read command number #RD_T_{C1&C2} is ‘15’. This operation corresponds to step S2200 of FIG. 12.

As a result of the comparison \textcircled{b}, since the outstanding normal-command count #N_RD is less than the read command number #RD_T_{C1&C2}, the first core CORE_1 further compares the outstanding normal-command count #N_RD with the first core read number #RD_T_{C1}, where #RD_T_{C1} is ‘10’. This operation corresponds to step S2410 of FIG. 13.

As a result of the comparison \textcircled{b}-\textcircled{1}, since the outstanding normal-command count #N_RD is less than the first core read number #RD_T_{C1}, the first core CORE_1 assigns all of the normal-read commands RD_CMD<06:13> to the first command processing operation RD1. The first core CORE_1 may assign the #M pre-read commands RD_CMD<16:20> to the second command processing operation RD2. Furthermore, the first core CORE_1 may additionally assign the remaining pre-read commands RD_CMD<14:15> to the first command processing operation RD1. This operation corresponds to step S2420 of FIG. 13.

The ‘8’ normal-read commands RD_CMD<06:13> and the ‘2’ pre-read commands RD_CMD<14:15> are assigned to the first command processing operation RD1. The ‘5’ pre-read commands RD_CMD<16:20> are assigned to the second command processing operation RD2. The number of the normal-read commands assigned to the first command processing operation RD1 corresponds to the outstanding normal-command count #N_RD. The number of pre-read commands assigned to the second command processing operation RD2 may the reference number #M. The number of pre-read commands additionally assigned to the first command processing operation RD1 may be obtained by “#RD_T_{C1}−#N_RD”.

The first core CORE_1 and the second core CORE_2 may control the data storage device 150 to process the ‘8’ normal-read commands RD_CMD<06:13> and the ‘7’ pre-read commands RD_CMD<14:20> as a parallel-read operation RD_PRL for ‘40 ns’.

FIG. 16 illustrates an example of CASE 3, as described in step S2430 of FIG. 13. Portions overlapping with FIGS. 14A and 14B are omitted from the following description.

As illustrated in FIG. 16, the read commands RD_CMD<06:15> are normal-read commands, and the read commands RD_CMD<16:23> are pre-read commands among the unprocessed read commands RD_CMD<06:23>. The first core CORE_1 may calculate the outstanding normal-command count #N_RD, where #N_RD is ‘10’.

The first core CORE_1 may compare the outstanding normal-command count #N_RD with the read command number #RD_T_{C1&C2}. In this case, the outstanding normal-command count #N_RD is ‘10’, and the read command number #RD_T_{C1&C2} is ‘15’.

As a result of the comparison \textcircled{b}, since the outstanding normal-command count #N_RD is less than the read command number #RD_T_{C1&C2}, the first core CORE_1 further compares the outstanding normal-command count #N_RD with the first core read number #RD_T_{C1}, where #RD_T_{C1} is ‘10’.

As a result of the comparison \textcircled{b}-\textcircled{2}, since the outstanding normal-command count #N_RD is equal to the first core read number #RD_T_{C1}, the first core CORE_1 assigns all of the normal-read commands RD_CMD<06:15> to the first command processing operation RD1. The first core CORE_1 may assign the #M pre-read commands RD_CMD<16:20> to the second command processing operation RD2.

The ‘10’ normal-read commands RD_CMD<06:15> are assigned to the first command processing operation RD1. The ‘5’ pre-read commands RD_CMD<16:20> are assigned to the second command processing operation RD2. The number of the normal-read commands assigned to the first command processing operation RD1 corresponds to the outstanding normal-command count #N_RD. The number of pre-read commands assigned to the second command processing operation RD2 may the reference number #M.

The first core CORE_1 and the second core CORE_2 may control the memory device 150 to process the ‘10’ normal-read commands RD_CMD<06:15> and the ‘5’ pre-read commands RD_CMD<16:20> as a parallel-read operation RD_PRL within ‘40 ns’.

FIG. 17 illustrates an example of CASE 4, as described in step S2440 of FIG. 13. Portions overlapping with FIGS. 14A and 14B are omitted from the following description.

As illustrated in FIG. 17, the read commands RD_CMD<06:19> are normal-read commands, and the read commands RD_CMD<20:23> are pre-read commands among the unprocessed read commands RD_CMD<06:23>. The first core CORE_1 may calculate the outstanding normal-command count #N_RD, where #N_RD is ‘14’.

The first core CORE_1 may compare the outstanding normal-command count #N_RD with the read command number #RD_T_{C1&C2}. The outstanding normal-command count #N_RD is ‘14’, and the read command number #RD_T_{C1&C2} is ‘15’.

As a result of the comparison \textcircled{b}, since the outstanding normal-command count #N_RD is less than the read command number #RD_T_{C1&C2}, the first core CORE_1 further compares the outstanding normal-command count #N_RD with the first core read number #RD_T_{C1}, where #RD_T_{C1} is ‘10’.

As a result of the comparison \textcircled{b}-\textcircled{3}, since the outstanding normal-command count #N_RD is greater than the first core read number #RD_T_{C1}, the first core CORE_1 assigns the ‘10’ normal-read commands RD_CMD<06:15> to the first command processing operation RD1. The ‘10’ corresponds to the first core read number #RD_T_{C1}. The first core CORE_1 assigns the ‘1’ pre-read command RD_CMD<20> to the second command processing operation RD2. Furthermore, the first core CORE_1 may additionally assign the ‘4’ normal-read commands RD_CMD<16:19> to the second command processing operation RD2.

In other words, the first command processing operation RD1 includes the ‘10’ normal-read commands RD_CMD<06:15>, and the second command processing operation RD2 includes ‘4’ normal-read commands RD_CMD<16:19> and the ‘1’ pre-read command RD_CMD<20>. The number of normal-read commands assigned to the first command processing operation RD1 corresponds to the first core read number #RD_T_{C1}. The number of pre-read commands assigned to the second command processing operation RD2 may be obtained by “#M−(#N_RD−#RD_T_{C1})”. The number of normal-read commands RD_CMD<16:19> additionally assigned to the second command processing operation RD2 may be obtained by “#N_RD−#RD_T_{C1}”.

The first core CORE_1 and the second core CORE_2 may control the memory device 150 to process the ‘14’ normal-read commands RD_CMD<06:19> and the ‘1’ pre-read command RD_CMD<20> as a parallel-read operation RD_PRL within ‘40 ns’.

Table 2 below shows the read methods for a plurality of read commands RD_CMD<06:20> as described in CASE 1 to CASE 4 in FIGS. 14A to 17.

As shown in Table 2, since the outstanding normal-command counts #N_RD in CASE 1 to CASE 4 are greater than the threshold count TH, the ‘15’ read commands RD_CMD<06:20> are processed by the parallel-read operation RD_PRL within the reference time T in all cases. The threshold count TH may include the reference count

TABLE 2

| | | Comparison | |
|---|---|---|---|
| CASE | #N_RD | result(S520) | RD_CMD<06:20> |
| 1 | 15 | #N_RD > TH | RD_PRL |
| 2 | 8 | | |
| 3 | 10 | | |
| 4 | 14 | | |

However, as shown in Table 3, not all normal-read commands N_RD_CMD included in the ‘15’ read commands RD_CMD<06:20> are processed using the parallel-read operation RD_PRL. In CASE 1 and CASE 4, the normal-read commands N_RD_CMD are processed using the parallel-read operation RD_PRL. In CASE 2 and CASE 3, the normal-read commands N_RD_CMD are processed using the single-read operation RD_S.

TABLE 3

| CASE | #N_RD | Comparison result | | N_RD_CMD |
|---|---|---|---|---|
| 1 | 15 | \textcircled{a}: #N_RD ≥ #RD_T_{C1&C2} | | RD_PRL |
| 2 | 8 | \textcircled{b}: #N_RD < | \textcircled{b}-\textcircled{1}: #N_RD < RD_T_{C1} | RD_S |
| 3 | 10 | #RD_T_{C1&C2} | \textcircled{b}-\textcircled{2}: #N_RD = RD_T_{C1} | RD_S |
| 4 | 14 | | \textcircled{b}-\textcircled{3}: #N_RD > RD_T_{C1} | RD_PRL |

The outstanding normal-command count #N_RD indicates the number of unprocessed normal-read commands. The first core read number #RD_T_{C1} indicates the estimated number of read commands that the first core CORE_1 can complete within the reference time T. When the outstanding normal-command count #N_RD is less than (\textcircled{b}-\textcircled{1}) or equal to (\textcircled{b}-\textcircled{2}) the first core read number #RD_T_{C1}, the single-read time tRD_S for the unprocessed normal-read commands is less than or equal to the parallel-read time tRD_PRL. In this case, the controller 130 determines that it is more advantageous to use the single-read operation RD_S and thus assigns the normal-read commands only to the first command processing operation RD1, as in CASE 2 and CASE 3. On the other hand, when the outstanding normal-command count #N_RD is less than the read command number #RD_T_{C1&C2} (\textcircled{b}) and greater than the first core read number #RD_T_{C1} (\textcircled{b}-\textcircled{3}), the parallel-read time tRD_PRL is shorter than the single-read time tRD_S. Accordingly, the controller 130 determines to use the parallel-read operation RD_PRL, assigning the normal-read commands to both the first and second command processing operations RD1 and RD2, as in CASE 1 and CASE 4.

Since the normal-read command N_RD_CMD is directly related to the read request RD_REQ received from the host 102, the response time of the normal-read command is a critical performance factor.

However, as described in FIGS. 8 to 9B, if the controller 130 performs the parallel-read operation RD_PRL without considering the outstanding normal-command count #N_RD or the operating speeds and workloads of the first core CORE_1 and the second core CORE_2, the response time for the host read request RD_REQ may become excessively long.

Accordingly, the controller 130, according to embodiments of the disclosed technology, may determine whether to perform the parallel-read operation RD_PRL based on a comparison between the single-read time tRD_S and the parallel-read time tRD_PRL. The single-read time tRD_S and the parallel-read time tRD_PRL depend on a comparison between the outstanding normal-command count #N_RD and the first core read number #RD_T_{C1}. The controller 130 performs the parallel-read operation RD_PRL for the normal-read command N_RD_CMD only when the parallel-read time tRD_PRL is expected to be shorter than the single-read time tRD_S.

The controller 130 may estimate the single-read time tRD_S based on the outstanding normal-command count #N_RD and the first unit read time tUNIT__{C1} of the first core CORE_1. Similarly, the parallel-read time tRD_PRL may be estimated as the maximum of the predicted completion times for the first command processing operation RD1 and the second command processing operation RD2. The controller 130 may then selectively perform the parallel-read operation RD_PRL only when the estimated parallel-read time tRD_PRL is less than the estimated single-read time tRD_S, thereby optimizing the overall response time for host read requests.

The above description is merely examples of various implementations of the disclosed technology, and those skilled in the art will appreciate that various modifications and variations may be made based on what is described or illustrated in this document.y.

What is claimed is:

1. A data storage system, comprising:
a data storage device including a storage region configured to store data; and
a controller in communication with a host outside the data storage system and configured to receive read requests from the host and control the data storage device by generating first read commands to perform first read operations to read the data corresponding to first addresses corresponding to the read requests received from the host,
wherein the controller is further configured to:
generate second read commands to perform second read operations to read the data corresponding to second addresses that are consecutive to the first addresses, in response to presence of a parallel-read execution condition during processing of the first read commands;
make a comparison of a read command number with an outstanding first read count indicating a number of unprocessed first read commands, wherein the read command number represents a number of read commands that are processable by the controller within a reference time and include at least one of the first read commands and the second read commands;
assign each of the first read commands and the second read commands to either a first command processing operation or a second command processing operation based on a result of the comparison; and
perform the first and second command processing operations in parallel within the reference time.

2. The data storage system of claim 1, wherein the controller includes:
a first core configured to perform the first command processing operation; and
a second core configured to perform the second command processing operation under control by the first core.

3. The data storage system of claim 2, wherein the reference time includes:
a time required for the second core to complete a particular number of the second read commands, the particular number being a reference count.

4. The data storage system of claim 3, wherein the reference time further includes:
a task processing time required for the second core to complete a task assigned prior to the second command processing operation.

5. The data storage system of claim 3, wherein the controller further includes:
a cache memory configured to store consecutive data read from the data storage device by the first and second command processing operations,
wherein the controller is configured to transmit the consecutive data stored in the cache memory to the host in response to the read requests.

6. The data storage system of claim 5, wherein the reference count corresponds to a size of a portion of the cache memory allocated to the second core.

7. The data storage system of claim 5, wherein the reference count corresponds to a size of a data segment that is transmitted to the host in a single transfer.

8. The data storage system of claim 3, wherein the controller is configured to calculate the read command number by summing a first core read count and the reference count,
wherein the first core read count represents a number of the first read commands processable by the first core through the first command processing operation within the reference time.

9. The data storage system of claim 1, wherein the controller is configured to assign only the first read commands to the first and second command processing operations in response to the outstanding first read count being greater than or equal to the read command number.

10. The data storage system of claim 1, wherein the controller is configured to assign the first read commands to the first command processing operation and assign the second read commands to the second command processing operation in response to the outstanding first read count is less than the read command number.

11. The data storage system of claim 10, wherein the controller is configured to additionally assign the second read commands to the first command processing operation in response to the outstanding first read count being less than a first core read count processable by a first core within the reference time.

12. The data storage system of claim 10, wherein the controller is configured to additionally assign the first read commands to the second command processing operation in response to the outstanding first read count being greater than a first core read count processable by a first core within the reference time.

13. The data storage system of claim 2, wherein the controller is configured to control the data storage device such that the first and second command processing operations are completed simultaneously.

14. The data storage system of claim 1, wherein the storage region comprises at least one of a volatile memory or a non-volatile memory.

15. The data storage system of claim 1, wherein the controller is configured to determine that the parallel-read execution condition is satisfied when the outstanding first read count is greater than a threshold value.

16. The data storage system of claim 2, wherein the controller is configured to assign the first read commands to the first and second command processing operations in response to the outstanding first read count being greater than a first core read count processable by the first core within the reference time.

17. The data storage system of claim 2, wherein the controller is configured to assign the first read commands only to the first command processing operation in response to the outstanding first read count being less than or equal to a first core read count processable by the first core within the reference time.

18. A method of operating a data storage system, wherein the data storage system includes a data storage device having a storage region configured to store data and a controller configured to control the data storage device, and wherein the method comprises:
generating first read commands to read the data corresponding to first read requests received from a host that is outside the data storage system;
generating second read commands to read data corresponding to second addresses that are consecutive to first addresses of unprocessed first read commands, in response to a parallel-read execution condition being satisfied;
making a comparison of a read command number with an outstanding first read count indicating a number of the unprocessed first read commands, wherein the read command number represents a number of read commands that are processable by the controller within a reference time and include at least one of a number of first read commands and the second read commands;
assigning each of the unprocessed first read commands and the second read commands to either a first command processing operation or a second command processing operation, based on a result of the comparison; and
performing the first and second command processing operations in parallel during the reference time.

19. The method of claim 18, wherein the first command processing operation is processed by a first core for performing the first read commands, and
wherein the second command processing operation is processed by a second core for performing the second read commands under control of the first core.

20. The method of claim 19, wherein the reference time includes a time required for the second core to complete a particular number of the second read commands, the particular number being a reference count.

21. The method of claim 19, wherein the reference count corresponds to a size of a portion of a cache memory allocated to the second core.

22. The method of claim 19, wherein the reference count corresponds to a size of a data segment that is transmitted to the host in a single transfer.

23. The method of claim 18, wherein the assigning each of the first and second read commands, includes:
assigning only the first read commands to the first and second command processing operations in response to the outstanding first read count being greater than or equal to the read command number.

24. The method of claim 23, wherein the number of the first read commands assigned to the first command processing operation corresponds to a first core read count processable by the first core within the reference time, and
wherein the number of the first read commands assigned to the second command processing operation corresponds to the reference count.

25. The method of claim 18, wherein the assigning each of the first and second read commands includes:
assigning the first read commands to the first command processing operation; and assigning the second read commands to the second command processing operation when the outstanding first read count is less than the read command number.

26. The method of claim 25, further comprising: additionally assigning the second read commands to the first command processing operation in response to the outstanding first read count being less than a first core read count processable by the first core within the reference time,
wherein a number of the second read commands that have been additionally assigned to the first command processing operation is obtained by subtracting the outstanding first read count from the first core read count.

27. The method of claim 25, further comprising: additionally assigning the first read commands to the second command processing operation in response to the outstanding first read count being greater than a first core read count processable by the first core within the reference time,
wherein a number of the second read commands that have been additionally assigned to the second command processing operation is obtained by subtracting the first core read count from the outstanding first read count.
